(19) United States
(12) Patent Application Publication
(10) Pub. No.: US 2002/0067018 A1
(43) Pub. Date: Jun. 6, 2002

(54) Scooter

(76) Inventor: Anthony Shaw, Taichung (TW)

Correspondence Address: BROWDY AND NEIMARK, P.L.L.C., 624 NINTH STREET, NW, SUITE 300, WASHINGTON, DC, 20001-5303, US

(21) Appl. No.: 09/729,794

(22) Filed: Dec. 6, 2000

(51) Int. Cl. B62M 1/00; B62M 29/00

(52) U.S. Cl. 280/220; 280/87.041

(57) ABSTRACT

A scooter comprises a deformable footboard, a handlebar frame fastened with the front end of the footboard, a front wheel pivoted to the bottom end of the handlebar frame, a rear wheel pivoted to the rear end of the footboard, and a one-way driving mechanism disposed at a pivoting portion of the rear wheel and the rear end of the footboard to cause the rear wheel to turn unidirectionally at the time when the footboard is caused by an external force to deform.

### FIELD OF THE INVENTION

The present invention relates generally to a human-powered vehicle, and more particularly to a scooter.

### BACKGROUND OF THE INVENTION

As shown in FIG. 1, a prior art scooter comprises a footboard 1, a handlebar frame 2 fastened with the front end of the footboard 1, a rear wheel 3 fastened with the rear end of the footboard 1, and a front wheel 4 fastened with the bottom end of the handlebar frame 2. The scooter is moved by a series of pushes made by one foot against the ground, with another foot of a rider being kept on the footboard 1.

### SUMMARY OF THE INVENTION

The primary objective of the present invention is to provide a scooter with a mechanical means to drive the scooter.

The scooter of the present invention comprises an arcuate and deformable footboard, a handlebar frame fastened with the front end of the footboard, a front wheel fastened with the bottom end of the handlebar frame, a rear wheel fastened with the rear end of the footboard, and a one-way driving mechanism. The rear wheel is driven by the one-way driving mechanism to move the scooter forward.

### BRIEF DESCRIPTION OF THE DRAWINGS

FIG. 1 shows a schematic view of a prior art scooter.

FIG. 2 shows a perspective view of a preferred embodiment of the present invention.

FIG. 3 shows a sectional view taken along the direction indicated by a line 3-3 as shown in FIG. 2.

FIG. 4 shows a sectional view taken along the direction indicated by a line 4-4 as shown in FIG. 3.

FIG. 5 shows a schematic view of the preferred embodiment of the present invention in a stationary state.

FIG. 6 shows a schematic view of the preferred embodiment of the present invention in motion.

FIG. 7 shows a schematic view of the preferred embodiment of the present invention having completed a full cycle of motion.

FIG. 8 shows a schematic view of a one-way driving mechanism of a second preferred embodiment of the present invention.

FIG. 9 shows a schematic view of a third preferred embodiment of the present invention.

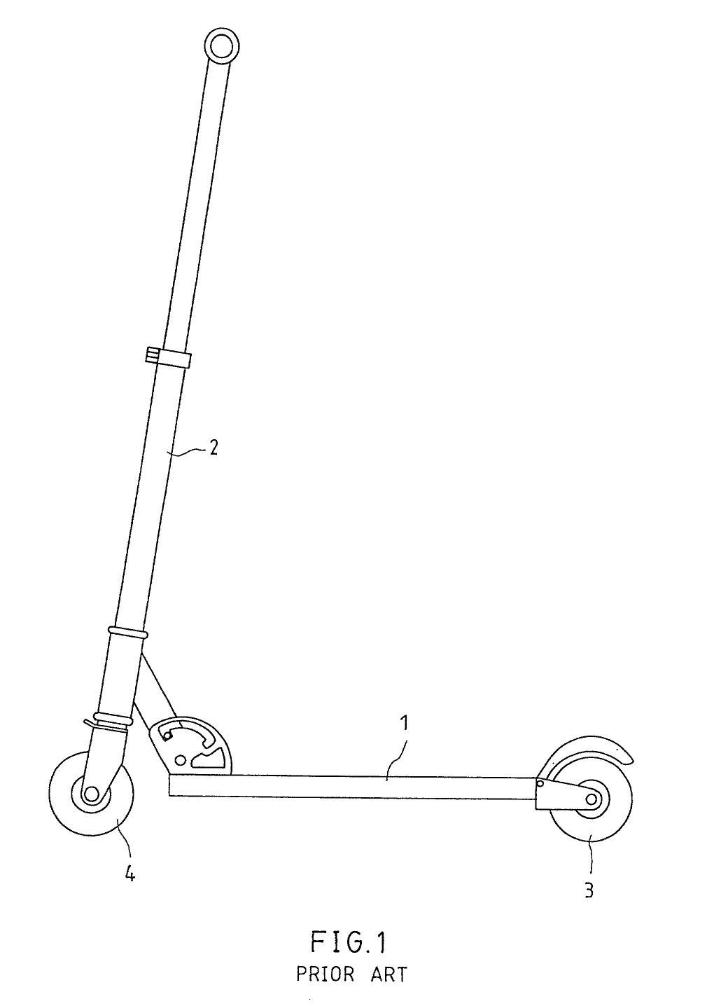

### DETAILED DESCRIPTION OF THE INVENTION

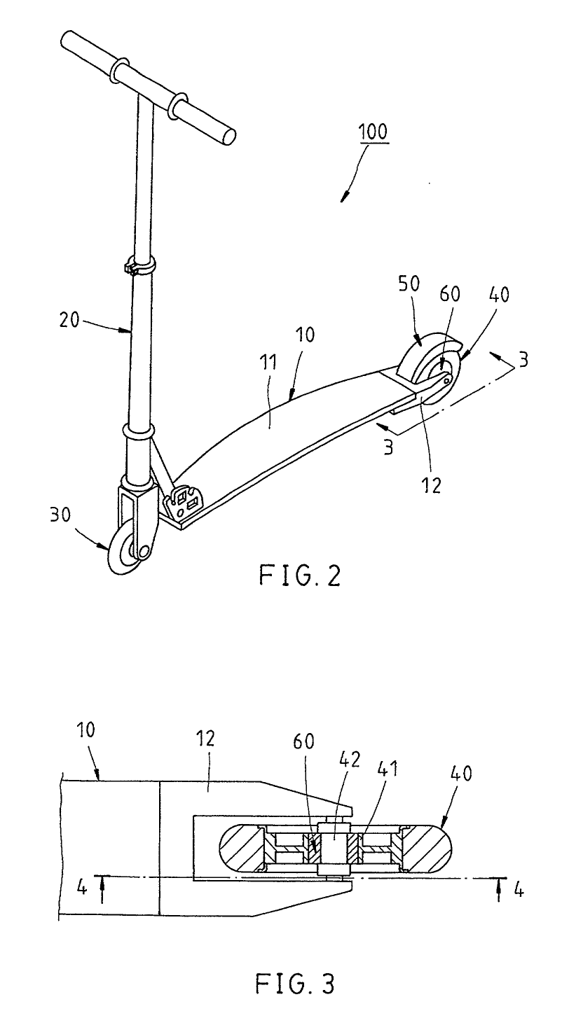

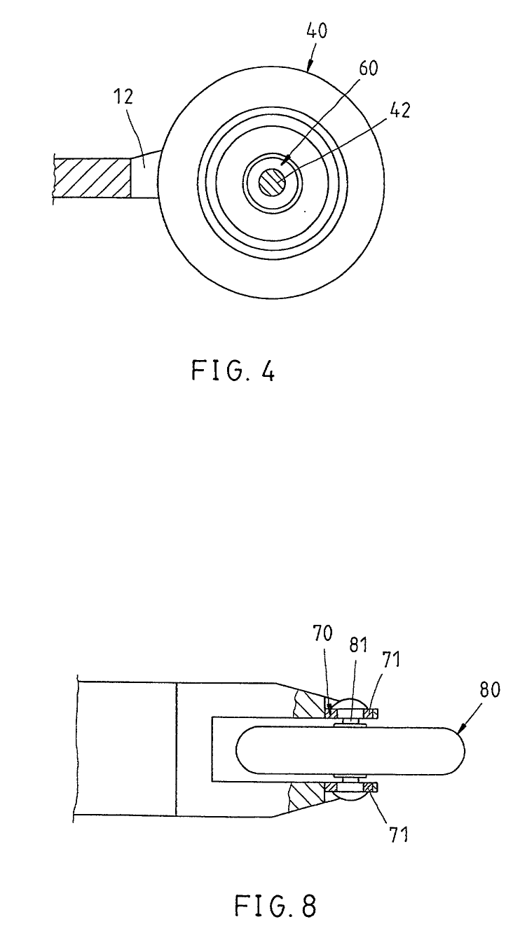

As shown in FIGS. 2-4, a scooter 100 embodied in the present invention is formed of a footboard 10, a handlebar frame 20, a front wheel 30, a rear wheel 40, a braking member 50, and a one-way driving mechanism 60.

The footboard 10 is made of a pliable, deformable synthetic board and is provided at the center with an archlike portion 11 capable of deforming and swiveling up and own at the time when the archlike portion 11 is exerted on by a longitudinal external force. As a result of the deformation, the length of the footobard 10 is changed. The footboard 10 is provided at the rear end with a forked portion 12.

The handlebar frame 20 is pivoted with the front end of the footbaord 10, and is provided with two grips.

The front wheel 30 is fastened to the bottom end of the handlebar frame 20.

The rear wheel 40 has a shaft hole 41 and a pin 42 which is put through the shaft hole 41 to fasten the rear wheel 40 with the forked portion 12 of the footboard 10.

The braking member 50 is pivoted at one end with the rear end of the footboard 10 for slowing or stopping the motion of the rear wheel 40.

The one-way driving mechanism 60 is a one-way bearing, which is lodged in the shaft hole 41 of the rear wheel 40 such that the pin 42 is put through the one-way bearing 60 capable of one-way rotation in relation to the fixed pin 42. The present invention may comprise a ratchet wheel mechanism in place of the one-way driving mechanism 60.

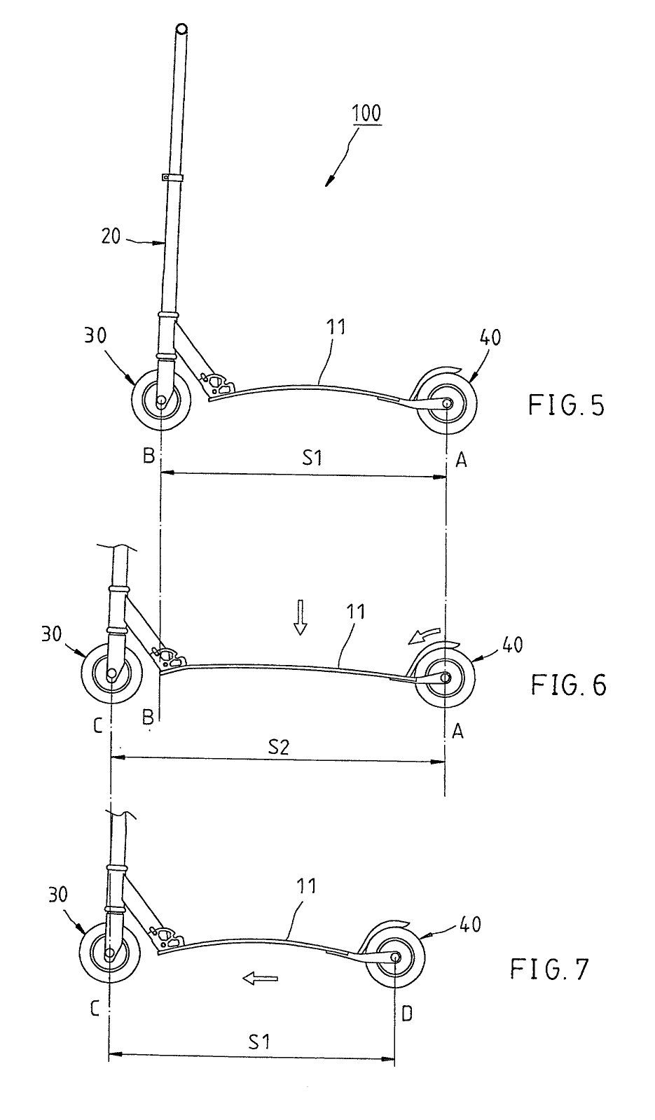

As illustrated in FIG. 5, the scooter 100 of the present invention is not in motion such that the footboard 10 is not deformed. The positions of the rear wheel 40 and the front wheel 30 are respectively denoted by A and B. The distance between A and B is denoted by S1. As shown in FIG. 6, the archlike portion 11 of the footboard 10 is exerted on by an external force, thereby resulting in deformation of the archlike portion 11. In light of the rear wheel 40 being allowed to turn only in a forward direction, the rear wheel 40 (A) forms a fixed point. As the footboard 10 is deformed, the front wheel 30 (B) is forced to move forward to the C position. The distance between A and C is denoted by S2. As a rider of the scooter 100 sways his or her body to cause the footboard 10 to arch once again, the rear wheel 40 turns forward instantaneously to the D position. The distance between the C position and the D position is equal to S1, as shown in FIG. 7. The scooter 100 is thus moved by the rider's body which sways in a reciprocating manner. In other words, the scooter 100 is driven by the deformation of the footboard 10, which results in a change in the distance between the front wheel 30 and the rear wheel 40.

As shown in FIG. 8, the second preferred embodiment of the present invention is basically similar in construction to the first preferred embodiment described above, except that the former comprises a one-way driving mechanism 70 which is formed of two one-way bearings 71, with each being disposed in the side wall of the rear end of the footboard 10 such that two ends of a fixed shaft 81 of the rear wheel 80 are received in the one-way bearing 71.

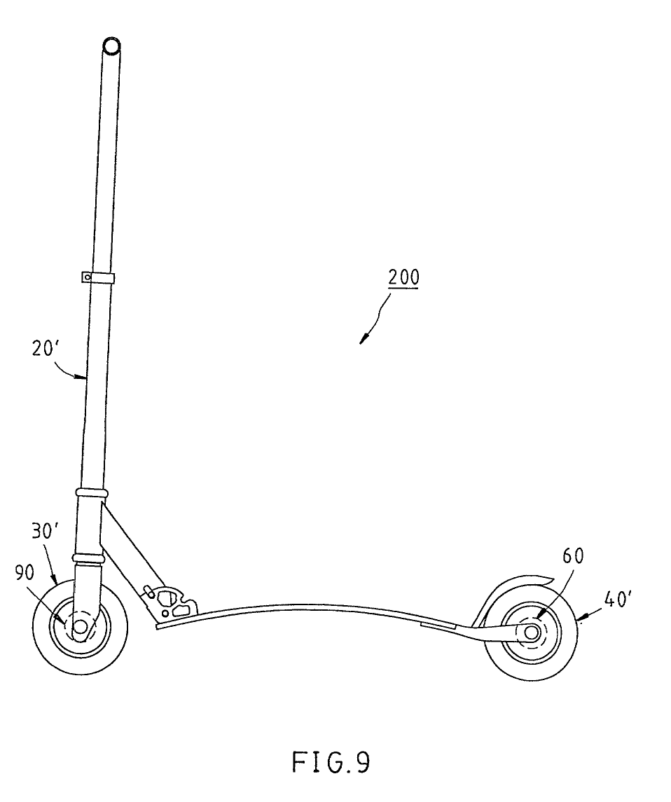

As shown in FIG. 9, a scooter 200 of the third preferred embodiment of the present invention comprises a one-way driving mechanism 90, which is mounted at the pivoting portion of the front wheel 30′ and the handlebar frame 20′. As a result, both front wheel 30′ and rear wheel 40′ are provided with the one-way driving mechanism, so as to prevent the scooter 200 in motion from bringing about a reverse resistance.

What is claimed is:

1. A scooter comprising:
a deformable footbaord having a arched portion capable of being deformed by an external force to swing up and down;
a handlebar frame fastened with a front end of said footboard;
a front wheel pivoted to a bottom end of said handlebar frame;
a rear wheel pivoted to a rear end of said footboard; and
a one-way driving mechanism disposed at a pivoting portion of said rear wheel and said footboard to cause said rear wheel to turn only in one direction at the time when said arched portion of said footboard is deformed.

2. The scooter as defined in claim 1, wherein said one-way driving mechanism has a one-way bearing; wherein said footboard is provided at the rear end with a pin; wherein said rear wheel is pivoted by said pin whereby said pin is put into said one-way bearing.

3. The scooter as defined in claim 1, wherein said one-way driving mechanism has two one-way bearings; wherein said footboard is provided at the rear end with a forked portion having two side walls to which said two one-way bearings are fastened; wherein said rear wheel has a shaft whereby both ends of said shaft are disposed in said two one-way bearings.

4. The scooter as defined in claim 1 further comprising another one-way driving mechanism which is disposed at a pivoting portion of said front wheel and said bottom end of said handlebar frame to cause said front wheel to turn only in one direction.

5. The scooter as defined in claim 1, wherein said footboard is provided at the rear end with a braking member pivoted thereto for slowing or stopping the motion of said rear wheel.
